(19) United States
(12) Patent Application Publication
(10) Pub. No.: US 2022/0055881 A1
(43) Pub. Date: Feb. 24, 2022

(54) DEVICE FOR FILLING AND CLOSING CONTAINERS

(71) Applicant: KHS GmbH, Dortmund (DE)

(72) Inventor: Dieter-Rudolf Krulitsch, Bad Kreuznach (DE)

(21) Appl. No.: 17/275,065

(22) PCT Filed: Oct. 1, 2019
(86) PCT No.: PCT/EP2019/076551

§ 371 Date: Mar. 10, 2021

(30) Foreign Application Priority Data
Oct. 9, 2018 (DE) 10 2018 124 874.1

(51) Int. Cl. B67C 7/00; B67C 3/26; B67B 3/02

(52) U.S. Cl. CPC B67C 7/0006; B67C 3/26; B67B 3/02; B67C 2003/2697; B67C 2007/0066; B67C 2003/2668; B67C 2007/006

(57) ABSTRACT

A multi-purpose container-handler includes a carrier for receiving and carrying the container, a handling station extending along a vertical axis, and a filling-and-closing member arranged on the handling station, connected to a filling product supply and a closure supply, and configured to both fill and close the container at the handling station. The filling-and-closing member comprises a filling valve and a mating holder, both of which are above the carrier. The carrier and the mating holder carry out controlled vertical movement relative to one another to cause the carrier and the mating holder to transition between a starting position, a filling position, and a closing position. The mating holder and the carrier are configured such that either mating holder or carrier generates a controlled force, which is either being a closing force directed vertically downward or a holding force directed vertically upwards.

### RELATED APPLICATIONS

This is the national stage of international application PCT/EP2019/076551, filed on Oct. 1, 2019, which claims the benefit of the Oct. 9, 2018 priority date of German application DE102018124874.1, the contents of which are herein incorporated by reference.

### FIELD OF INVENTION

The invention relates to a device for filling containers with a liquid filling product and for closing the containers with a closing cover, in particular a crown cork.

### BACKGROUND

Within the beverage industry, there exist container-handling machines that that operate at capacities of upwards of ten thousand to fifty thousand containers per hour. These container-handling machines are of various types, such as filling machines that fill containers and closing machines that close the containers with various closures, such as crown corks. The filling machines typically have plural handling stations or filling stations. Each filling station has a filling element having a valve for dispensing the liquid filling product.

In “free jet filling,” the product flows in a free jet that is neither influenced nor altered by guiding elements, such as deflecting screens, swirl bodies, or short or long filling pipes. Free-jet filling can be carried out both at ambient pressure and under pressure. In the former, the container being filled generally does not contact the filling element. However, in some cases, it does. Under these conditions, it is useful to have a gas passage produces a connection between the container's interior and the environment. Such a passage permits gas in the container to be escape into the surrounding environment.

In those cases in which free-jet filling takes place in a pressurized environment, the container is pressed with its mouth against the filling element and tightly sealed. The pressure within the container, which differs from that of the ambient pressure, is then adjusted, either by adding a pre-stressing gas or by imposing a negative pressure. The interior pressure can thus be higher or lower than ambient pressure. the pressure in the interior of the container, differing from ambient pressure, is adjusted by the imposition of a prestressing gas or by the imposition of a negative pressure. The adjusted pressure can lie above or below the ambient pressure.

Closing machines likewise have plural handling stations, which in this case are closing stations. Each closing station has a closing tool with a closing stamp that presses the crown cork onto the container's mouth and deforms it so that it seals the container. The closing machine is different from the filling machine and undergoes different movement sequences.

A filling machine often has lifts that raise containers towards the filling valve and presses it tightly against an opening to seal the container. The forces required are generally high. As a result, the component parts must be sufficiently stable to sustain such high forces.

In closing machines, particularly those that in which the closure is a crown cork, it is necessary to stamp the closure against the container with considerable force to deform it so that it seals the container and to then deform the projecting edge using a drawing ring that moves from the top downwards. The resulting plastic deformation causes the closure's rim to come into close contact with the outside of the container's neck. This also requires substantial force to be exerted. As a result, the closing machine's components must be able to routinely sustain such forces.

### SUMMARY

A disadvantage of known systems is the need to have two separate machines: one for filling and one for closing. Thus consumes more space and raises costs. The high cost arises as a result of the need to duplicate components that can sustain high forces.

An object of the invention is therefore to provide a device for filling-and-closing containers that, in comparison with the prior art, allow for the filling-and-closing of containers with a simpler structural design and in an economical manner. The present invention provides a device for filling-and-closing containers that comprises at least one carrier element for carrying and holding the containers, and at least one filling-and-closing member arranged on at least one handling station of the device. The filling-and-closing member is connected to a filling material supply and a closing cover supply and comprises at least one filling valve and at least one mating holder arranged in the vertical direction above the containers to be filled and to be closed. The main aspect of the invention is to be seen in the fact that the carrier element and the mating holder are designed to perform a controlled movement relative to each other oriented in the direction of a vertical axis of the handling station, specifically in such a way that the carrier element and the mating holder assume at least one filling position and at least one closing position on account of the controlled relative movement, starting from an initial position relative to each other. In this situation, the device is set up both to fill and to close the containers at the at least one handling station.

The present invention is therefore to be understood as a container-handling machine with which the container is both filled and closed at a handling position or handling station, such that the device, according to the understanding of the present invention represents a container-handling machine that is configured as a filling-and-closing machine. The device according to the invention therefore carries out the movements required both for the filling as well as for the closing.

Particularly advantageously, with the present device the functions of a filling machine and the functions of a closing machine are combined in only one machine, wherein the necessary relative movements between the carrier element and the mating holder take place in a controlled manner, in particular can be controlled and regulated, and can be moved and adjusted exactly and precisely to different positions relative to one another. In this situation, the precision of the corresponding relative positioning, namely the precision of the controlled and regulated relative movement, is in particular in the millimeter range.

With the present device, particularly advantageously, a more simple machine is provided, with which the complete movement sequences and the generation of force that are necessary on the one hand at the filling of the containers and, on the other hand, at the closing of the containers, are put into effect by means of a movement mechanism, in particular one single mechanism, or, respectively, by means of one single mechanistic movement system, namely by the relative movement of the interacting elements of the carrier element and the mating holder.

According to the understanding of the present invention, the elements that move relative to one another, the “carrier element and mating holder”, are very basically regarded as controlled members, in particular as controlled and regulated members, which are moved over a predetermined movement path or lift, wherein the members which are moved in such a controlled and regulated manner are also understood in this situation as being lifting members, which carry out a predetermined lifting movement, in particular a lift in a vertical direction, namely perpendicularly upwards and/or downwards. In this situation, the lifting element can be controlled mechanically or electronically. Known for such a control and/or regulation purpose are, for example, the imposition of compressed air, curved tracks, linear motors, or the like.

According to one preferred embodiment variant, the carrier element is configured in the form of a lifting member that can be lowered and raised in the direction of the vertical axis, wherein the lifting element is driven so as to carry out the lowering and lifting movements mechanically controlled or pneumatically controlled or electrically controlled, and wherein the lifting element is designed at least to raise the containers out of a supply plane running at a first height level into at least one filling plane running at a higher second height level, and into at least one closing plane running at a higher third height level. For particular preference, in this situation a linear drive is provided for driving the lifting element.

In this situation, the container that is to be filled, as a rule a bottle, is handed over in the supply plane to the carrier element, in particular the lifting element, and stands on this on a container base. For the filling, the container, in particular the bottle, is raised by the lifting element up to a filling height, namely to the filling plane, at which, for example, the sealing position of the container mouth with the dispensing opening of the filling valve is established. The container, filled but still not closed, remains standing on the carrier element, which can also be designated as a bottle carrier. For the closing, a crown cork is provided, which is positioned, for example, lying on the container mouth, or is held above the container, for example by magnetic force, at a laterally movable slide element, or at a mating holder arranged above the container. By means of a further lift of the lifting element upwards, the container is raised to the closing height or, respectively, the closing plane. Since the mating holder or stamp is arranged above the bottle, this results in the container and the mating holder being able to be pressed against one another. Preferably, the contact pressure force can be changed, and can be adjusted to a desired value. Container and crown cork are therefore essentially tensioned between the carrier element and the mating holder. Due to the plastic deformation of the crown cork, for example due to a drawing ring provided in the filling-and-closing member, the container is finally closed with a tight seal by the crown cork.

According to the preferred solution described, the carrier element is therefore moved, and specifically in the direction towards the mating holder, wherein the carrier element, by way of the container, is pressed against the mating holder. Preferably, in this situation the mating holder is subjected to preliminary tension by springs, and, by way of the container, is pressed upwards, as a result of which the crown cork is pressed by a drawing ring, which is preferably fixed in position. Advantageously, in this situation it is possible to do without a mechanism for the perpendicular movement and force generation, for example a moved closure element.

According to an alternative preferred embodiment, the mating holder arranged above the container is configured for a lowering and raising movement in the direction of the vertical axis, wherein, for carrying out the vertical movement, the mating holder is driven mechanically controlled or pneumatically controlled or electrically controlled. In particular, such a mating holder that can be lowered or raised in such a way can be understood as a controlled and regulated stamp. For example, in this case the mating holder is driven by a linear motor. In these embodiments the relative movement is effected by the movement of the mating holder. Advantageously, the movement of the mating holder can likewise be controlled exactly in this situation, such that a precise height positioning of the mating holder takes place, in particular precise in the millimeter range.

It is of course understood that embodiment variants are also included by the present invention with which both the carrier element as well as the mating holder are configured for a raising and lowering movement, in particular for a controlled and regulated movement. The relative movement can then be put into effect by the controlled raising and/or lowering movement of both elements.

Preferably, the mating holder and/or the carrier element arranged above the containers are power-controlled, wherein the mating holder is configured such as to produce a closing force directed vertically downwards, and/or wherein the carrier element is configured such as to produce a holding force directed vertically upwards. As a result, a perpendicular force and movement can be produced. The movement sequences can be different, and the force of the one actuation is compensated by a counter-force of the other actuation. With the combined filling-and-closing member provided in this situation, both actuations are used for the mechanical sequence.

For example, one of the controlled elements, the carrier element or the mating holder, carries out all the perpendicular main movements that are necessary for the filling-and-closing procedure, and specifically with the forces necessary for this purpose. The counter-forces are absorbed by the respective other element, preferably in the form of a fixed stop. Advantageously, the possibility is avoided in this case of two expensive and elaborate mechanisms working with force against one another. Spring packets for absorbing an overload or for the height compensation of the containers are possible on both sides.

According to a preferred embodiment variant, a process chamber or pressure chamber is formed in the filling-and-closing member, so as to receive at least one container mouth of a container that is to be filled and closed, and at least of one closing cover that is in contact on a contact surface of the mating holder.

For further preference, for the sealing of the process chamber or pressure chamber, a sealing arrangement with corresponding sealing elements is provided, wherein, during the filling-and-closing process, the sealing elements are arranged in a sealing position with a container neck arranged beneath the container mouth of the container.

According to a further preferred embodiment variant, due to their controlled movement relative to one another, the carrier element and the mating holder are configured so as to adopt at least one sealing position, wherein, in the sealing position, the sealing location of the sealing elements is produced with the container neck.

Likewise for preference, a drawing ring arrangement is further provided in the filling-and-closing member, for the plastic deformation of closing covers configured as crown corks, which for particular preference is configured so as to undertake lowering and raising movements in the direction of the vertical axis. The drawing ring arrangement comprises a drawing ring, which serves to deform the crown cork pressed against the container plastically, in such a way that this is connected securely to the container and closes it tightly in relation to the surrounding environment. The drawing ring is arranged above the container, which is not yet closed. For the actual closing of the container, i.e. for the plastic deformation of the crown cork, the crown cork, which is pressed/pre-tensioned against the container mouth, must be drawn at least by a part of the drawing ring. For this purpose, a relative movement is required between the drawing ring arrangement and the “pre-tensioned” container. For this purpose provision is made, for example, that either only the drawing ring or the “pre-tensioned” container is moved, or, however, also that both of them move.

Particularly advantageously, with the present device the functions of the carrier element or lifting element, of the mating holder or stamp respectively, and of the drawing ring are combined and put into effect in a new and advantageous manner, wherein all the functions are carried out by a relative movement or, respectively, by only one movement mechanism, in particular by one single element that is moved in a controlled and regulated manner.

Advantageously, with the present device, due in particular to the relative movements that are made possible with the present invention, it is possible, for example, for at least the movement sequences to be carried out, which are referred to hereinafter, wherein further intermediate steps may not be explicitly mentioned, but are likewise possible.

The individual steps can be listed as follows:

a) receiving of the container on the carrier element, namely the adopting of the starting position

b) moving at least of the container mouth into the process chamber or pressure chamber, namely the adoption of the sealing position

c) establishment of the sealing position between the container mouth and the dispensing opening of the filling valve, namely the adopting of the filling position

d) ending of the sealing position between the container mouth and the dispensing opening of the filling valve

e) positioning of the closing cover, in particular of the crown cork above the container mouth

f) pressing of the crown cork against the container mouth, namely the adoption of the closing position

g) relative movement at least of the crown cork by the drawing ring arrangement

h) removal of the container mouth or, respectively, of the container out of the process chamber or pressure chamber, namely return to the starting position.

For particular preference, the device is configured as a machine of circulating design, wherein, at the circumference of a machine carousel which can be driven by a motor such as to rotate about a vertical middle axis of the device, a number of handling stations are formed, and wherein several carrier elements are provided at a carousel under part, arranged beneath the carousel upper part, on a circulating carrier rim. For particular preference, with the device of circulating design, a height adjustment device is provided, wherein the height adjustment device is configured such as to adjust a vertical distance interval between the carousel upper part and the carousel lower part. Advantageously, the device can be adjusted to different height formats of the containers.

The present invention also comprises a method for filling-and-closing containers, with which the containers are conveyed to a device comprising at least one carrier element for the carrying receiving of the containers and at least one filling-and-closing member arranged on at least one handling station of the device and are handed over to the carrier element. With the method, the containers are then filled at the one handling station in at least one filling position, and then closed in at least one closing position with a closing cover, wherein the filling position and the closing position are adopted by carrying out a controlled relative movement of the carrier element, oriented in the direction of a vertical axis of the handling station, and of a mating holder provided in the filling-and-closing member.

Preferably, when adopting the filling position and the closing position, the containers are raised by means of the carrier element, starting from a supply plane into a higher filling plane, and into a still higher closing plane.

In addition or as an alternative, in order to produce the filling position and the closing position, the mating holder is moved in a controlled manner in the direction of the vertical axis of the handling station.

### BRIEF DESCRIPTION OF THE DRAWINGS

The invention is described in greater detail hereinafter on the basis of the figures, by a description of exemplary embodiments. The figures show:

FIG. 1 is a schematic view of a multi-purpose container-handler;

FIG. 2 shows a handling station from the multi-purpose container-handler shown in FIG. 1 at different handling positions;

FIG. 3 is an alternative embodiment of the multi-purpose container-handler shown in FIG. 1;

FIG. 4 shows different handling positions of a handling station in the multi-purpose container-handler shown in FIG. 3;

FIG. 5 shows an alternative embodiment of the multi-purpose container-handler shown in FIG. 1;

FIG. 6 shows different stages in the handling of a container using the multi-purpose container-handler shown in FIG. 5;

FIG. 7 shows a mechanism used in a handling station for moving a container and applying forces to it; and

FIG. 8 shows a filling-and-closing member used in the devices shown in the preceding figures.

### DETAILED DESCRIPTION

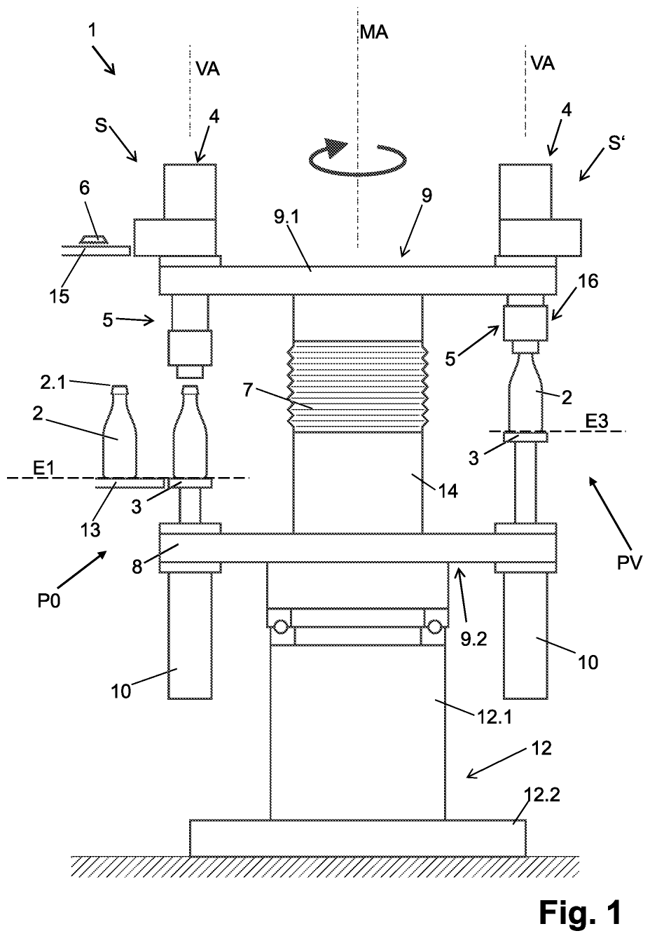

FIG. 1 shows a multi-purpose container-handler 1 that both fills and closes containers 2. The illustrated multi-purpose container-handler 1 is a rotating machine having handling stations 5, 5′ arranged around a vertical machine axis MA. Each handling station 5, 5′ extends along a vertical axis VA. The handling stations 5, 5′ are disposed along a circumference of a carousel 9. The carousel 9 includes an upper part 9.1 and a lower part 9.2 that is arranged vertically beneath the upper part 9.1. A motor rotates the carousel 9. Although only two handling stations 5, 5′ are shown, it is understood that there are many other.

A filling-and-closing member 4 is mounted on the upper part 9.1 The filling-and-closing member 4 extends along the vertical axis VA of a corresponding handling station 5, 5′.

The lower part 9.2 comprises a carrier rim 8. Carriers 3 along the carrier rim's circumference receive and carry containers 2. Each carrier 3 is assigned to a corresponding handling station 5, 5′. Each carrier 3 has a controlled or regulated drive. This drive is preferably a linear drive. A container 2 that is to be handled at a handling station 5, 5′ stands on the carrier 3 associated with that handling station 5, S′.

The multi-purpose container-handler 1 both fills containers with liquid filling-product and closes them with a closure 6. In the illustrated embodiment, the closure 6 is a crown cork.

The multi-purpose container-handler 1 lies downstream of a container-feeding machine and any other machines that carry out preceding container-handling steps. Examples of such machines are those that clean, sterilize, or inspect containers 2. Transport devices, such as transport belts, transport the containers 2 to the multi-purpose container-handler 1. A transfer element 13, such as an inlet star, transfers the containers into the multi-purpose container-handler 1. After having been filled and closed by the multi-purpose container-handler 1, containers 2 are passed along downstream by a transfer element, such as an outlet star.

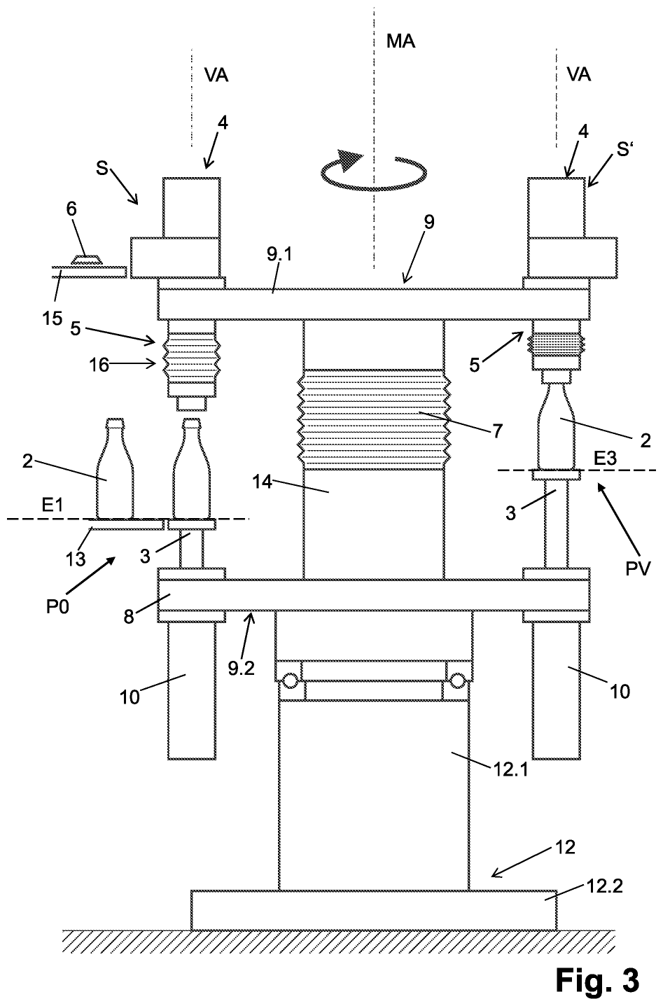

Referring now to FIG. 3, each filling-and-closing member 4 is connected to a closure supply 15 that supplies closures 6. Each filling-and-closing member 4 is also connected to a supply of liquid filling-material. However, this connection has been omitted for clarity.

The carousel 9 rotates on a base 12 about a central column 14 that extends vertically along the machine axis MA. The base 12 comprises a foot 12.1 connected to a machine foundation 12.2 that is mounted on a substrate. A height adjuster 7 arranged on the column 14 provides a way to move the upper part 9.1 and the lower part 9.2 relative to each other along the machine axis MA. This permits adjustment of the multi-purpose container-handler 1 for different container formats having different container heights. In addition, the carousel 9 can be adjusted to different heights.

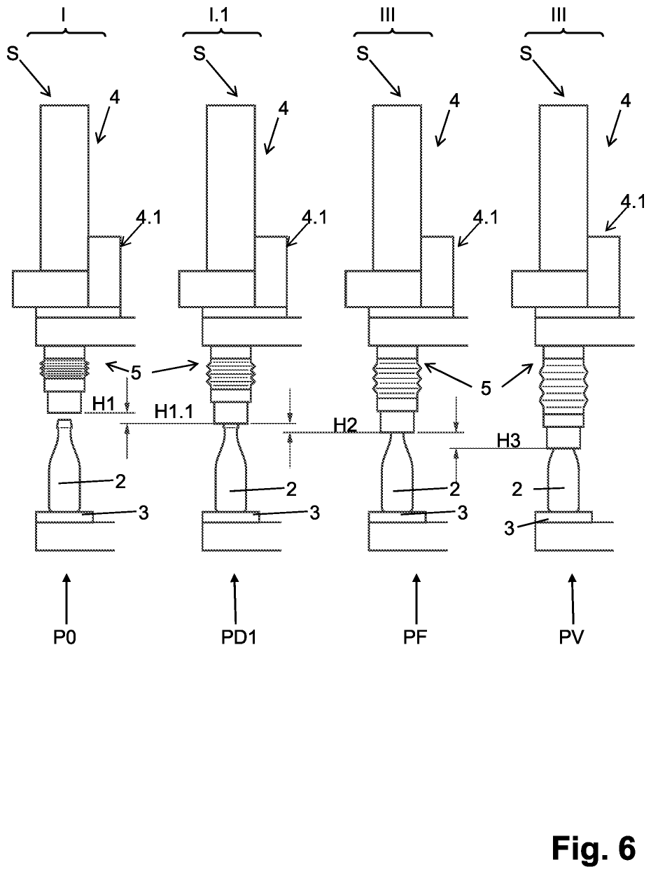

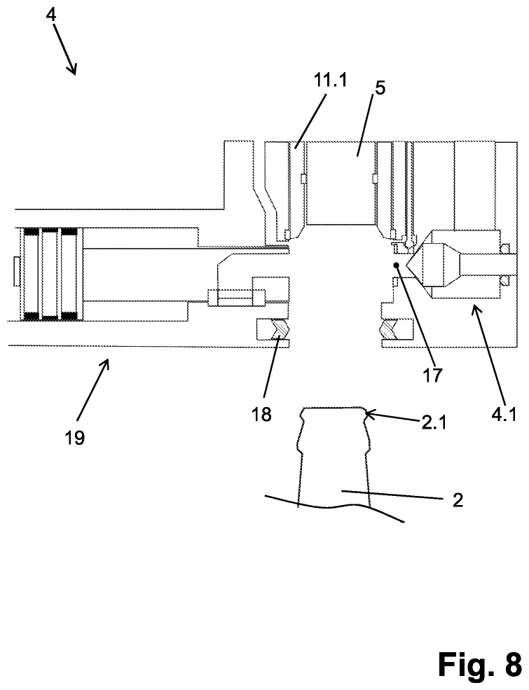

As shown in FIGS. 6 and 8, each filling-and-closing member 4 has a filling valve 4.1. Each filling-and-closing member 4 also has a mating holder 5 arranged above the container 2. During the closing of a container 2, the mating holder 5 carries out the function of a closing stamp. The filling valve 4.1 and the mating holder 5 are integrated into the filling-and-closing member 4 to form a combined tool. The carrier 3 and the mating holder 5 are configured so as to carry out controlled movement relative to one another along the handling station's vertical axis VA.

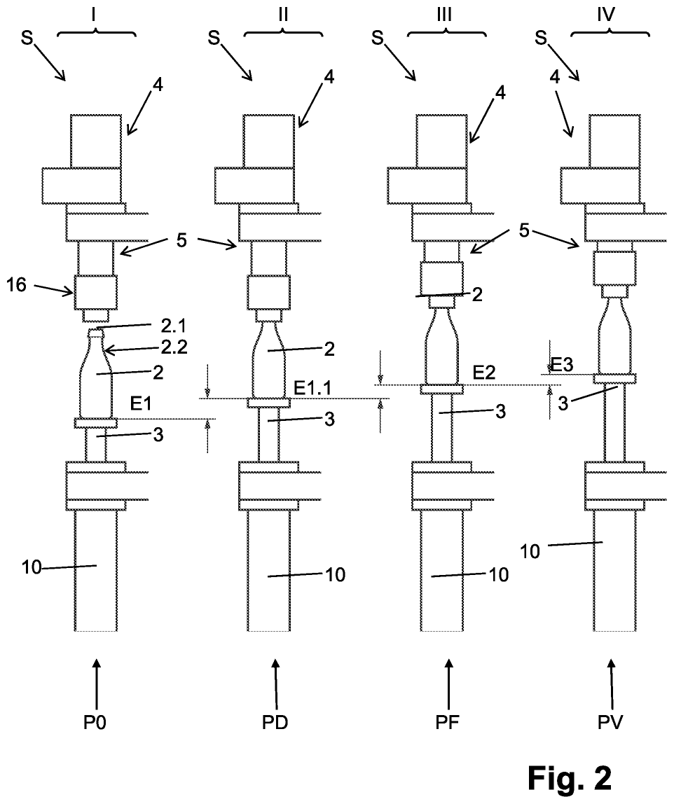

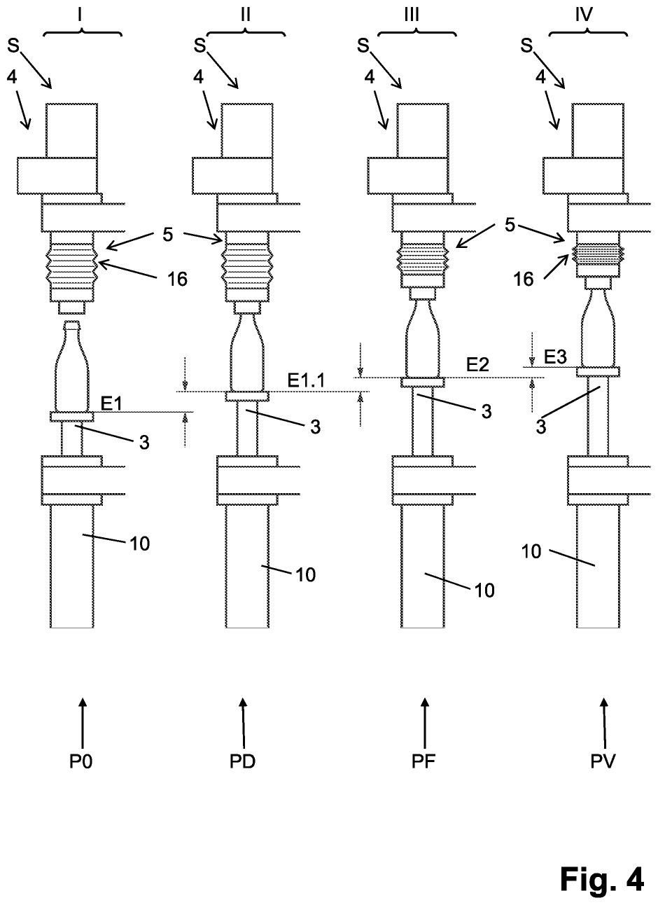

Referring to FIG. 2, as a result of this controlled movement, the carrier 3 and the mating holder 5 start from a starting position P0 and assume further positions relative to each other. These include a filling position PF and a closing position PV. In FIG. 1, the starting position P0 is shown at the first handling station 5 and the closing position is shown in the second handling station 5′. The filling position PF can be seen in FIG. 4. As a result, the multi-purpose container-handler 1 both fills and closes containers 2 at the handling station 5, 5′. FIGS. 2, 4, and 6 show different positions which the carrier 3 and mating holder 5 adopt relative to one another due to the controlled relative movement that occurs when filing and closing a container 2.

As shown in FIGS. 1 and 2, the carrier 3 lowers and lifts a container along the vertical axis in a controlled manner. As a result, the carrier 3 approaches the mating holder 5. In doing so, the carrier 3 starts at the starting position P0 at a supply plane E1 and rises to a sealing position PD at a sealing plane E1.1. It then rises to a filling position PF at a filling plane E2 and on to a closing position PV at a closing plane E3. The carrier 3 is then lowered back to the starting position P0 relative to the mating holder 5.

To adopt the sealing position PD, the container's mouth 2.1 is moved into the filling-and-closing member 4 from below at the free end side. The filling-and-closing member 4 comprises a centering-and-sealing arrangement 16 to receive the container 2. In the example from FIGS. 1 and 2, the centering-and-sealing arrangement 16 comprises a movable bottle-centering arrangement and a sliding seat.

Referring now to FIG. 8, the filing-and-closing member 4 features a chamber 17 formed therein. The chamber 17 is a process chamber or a pressure chamber. During the filling-and-closing process, the container mouth 2.1, the closure 6, and an underside of the mating holder 5 are all within the chamber 17. The sealing plane E1.1 is thus high enough so that the container 2 moves into the container centering-and-sealing arrangement 16 until the chamber 17 receives the container's mouth 2.1. In the process, corresponding seals 18 move with the container's neck 2.2 into the sealing position. This seals the chamber 17. Since the mouth 2.1 is already inside the chamber 17, this also seals the container 2.

To reach the filling position, the carrier 3 moves further upward in the vertical direction, thus raising the container 2 up to the filling plane E2. This results in a seal between the container's mouth 2.1 and a dispensing opening of the filling valve 4.1. In this position, the container is filled. Once the container has been filled, the seal can be broken. This marks a transition between the filling-and-closing member's filling function and its closing function.

The closing function begins with positioning a closure 6 above the mouth 2.1 so that an upper side of the closure 6 contacts the underside of the mating holder 5. The carrier 3 raises the container 2 still further into the closing position PV, shown in FIG. 2, up to the closing plane E3. This presses the container's mouth 2.1 against the closure 6 at a predetermined pressure, which in turn indirectly applies that force to the mating holder 5. The carrier 3 thus exerts an upward pressing force that presses against the closure 5 and the mating holder 5. The mating holder 5 therefore exerts an equal reaction force downward.

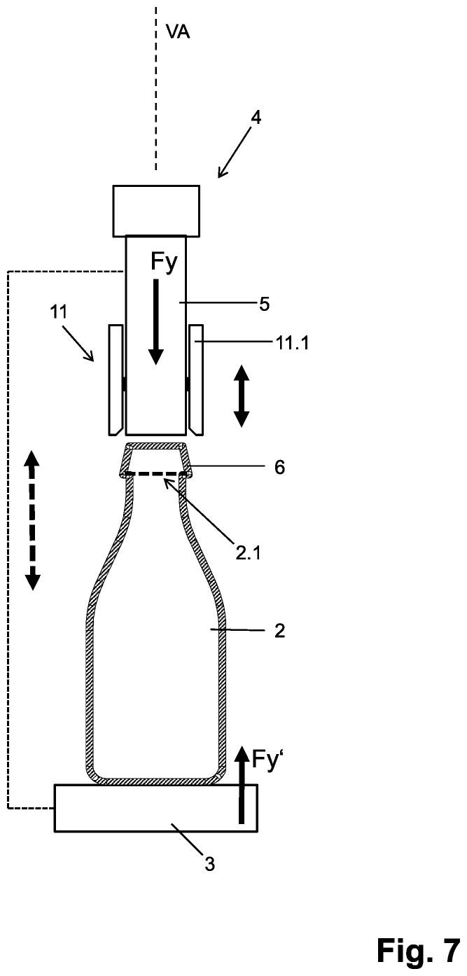

Referring now to FIG. 7, in a preferred embodiment, a spring biases the mating holder 5 so that as the carrier 3 rises, the mating holder 5 yields and moves upward. This allows a drawing ring 11.1 of a drawing ring arrangement 11.1 to apply a radially-inward force on the closure 6. The resulting force causes plastic deformation of the closure 6, thereby sealing the container. This concludes the closing process.

The carrier 3 executes a controlled pivot and lowers the now-closed container 2, thus releasing the mouth 2.1 from the chamber 17. The carrier 3 lowers the container 2 back to the supply plane E1 from which a downstream transfer element, such as an outlet star can remove the container.

In the embodiment shown in FIGS. 3 and 4, the centering-and-sealing element 16 includes a movable container-centering device such as a folding bellows. The remaining structures and operation are the same as those described in connection with FIG. 1.

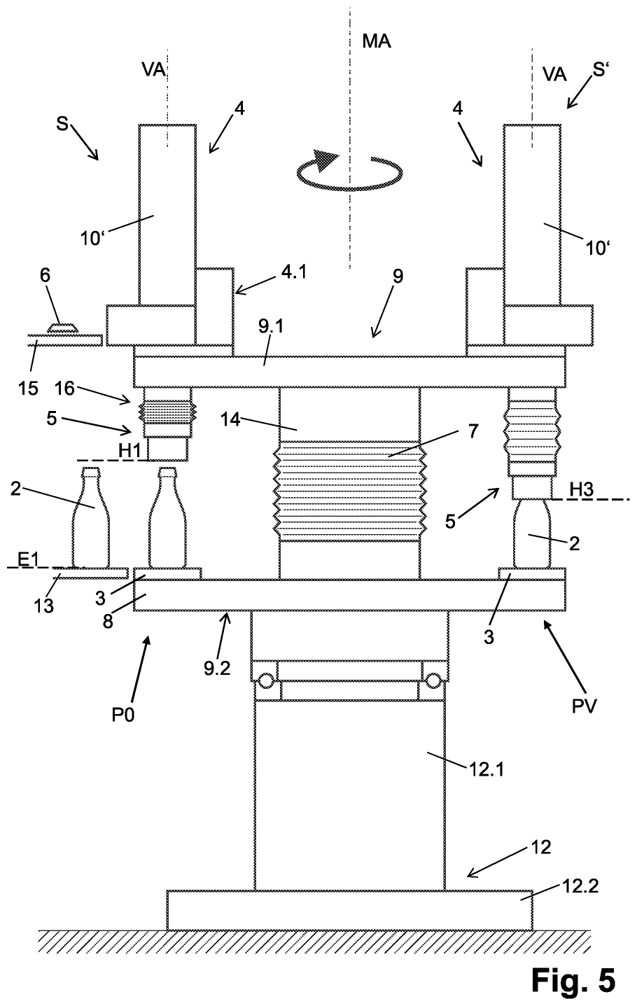

FIGS. 5 and 6 show an alternative embodiment in which the mating holder 5 moves up and down. Each filling-and-closing member 4 includes a centering-and-sealing arrangement 16 that is configured to center the container. The centering-and-sealing arrangement 16 features an elastic protection element such as a folding bellows. A linear drive 10′ provides controlled movement of each mating holder 5.

The mating holder 5, being integral with the filling-and-closing member 5, cannot be seen as it moves along the vertical axis VA. However, the different relative positions of the lower end of the filling-and-closing member 4 can be seen.

In this embodiment, the mating holder 5 approaches the carrier 4. As shown in FIG. 6, the mating holder 5 begins at a starting position P0 at starting height H1 and moves down to an intermediate position PD1 at an intermediate height H1.1 at which it closely approaches the container 2. At this point, the container 2 is not yet sealed. Then, it moves further down to the filling height H2 to attain a filling position PF. The holder 5 moves further down to the closing plane H3 to attain the closing position PV. The holder 5 then moves back up to attain its starting position P0 at the starting plane H1.

In the preceding embodiments, only one of the carrier 3 and the mating holder 5 carries out vertical motion. However, in some embodiments, both carry out vertical motion. Ultimately, it is not which element does the moving that matters but the relative motion of the elements.

Schematically represented once again in FIG. 7 is the interaction or effect mechanism respectively between the carrier 3 and mating holder 5. Due to the controlled relative movement to one another (indicated in FIG. 7 by the broken line double arrow) of the carrier 3 and of the mating holder 5, the distance interval between the carrier 3 and the mating holder 5 can be changed in a controlled manner. The container 2 which is to be filled and closed is arranged between the carrier 3 and the mating holder 5, wherein at least the position of the mating holder 5 changes during the performance of the different sequential function steps “Sealing”, “Filling”, and “Closing”, also in relation to the container 2. Due to the controlled relative movement, particularly advantageously, both the sealing position of the container mouth 2.1 with the filling valve 4.1 is established during the filling process, as well as the pressing pressure for the closure 6 during the closing process, wherein the container 2, in the closing position, with the closure 6 positioned on the container mouth 2.1, is tensioned between the carrier 3 and mating holder 5, and the mating holder 5 transfers or exerts a closing force Fy taking effect from above onto the closure 6, and therefore also onto the container 2. The container 2 is held by the carrier 3 with a holding force Fy′, directed upwards and counteracting the closing force Fy, wherein the closing force Fy and the holding force Fy′ in interaction cause the pressing of the closure 6 onto the container mouth 2.1, and the subsequent tight closing of the container 2.

As can be seen from FIG. 7, the carrier 3 and/or mating holder 5 can undergo lifting and lowering movement and can therefore cover a movement path along the vertical axis VA. The carrier 3 and/or mating holder 5 further produce a holding force Fy′ oriented upward along the vertical axis VA and a closing force Fy oriented in the opposite direction.

The plastic deformation of the closure's edge takes place by an at least partial drawing of the closure 6 through the drawing ring 11.1 of the drawing ring arrangement 11. In some embodiments, the drawing ring 11.1 is fixed and the container moves upwards relative to the drawing ring 11.1. In other embodiments, the drawing ring 11.1 moves along the vertical axis VA relative to the closure 6 or to the container, respectively. The possible movement of the drawing ring 11.1 is indicated in FIG. 7 by the double arrow with the continuous line.

FIG. 8 shows another embodiment of a filling-and-closing member 4 in which a container 2 is moved from the free-end side of the filling-and-closing member 4 in such a way that the container mouth 2.1 is arranged inside the chamber 17 and remains there during the entire filling-and-closing process. A regulated and/or controlled slide element 19 establishes the corresponding sealing position of the container mouth 2.1 with the filling valve's dispensing opening for the filling process. During the closing process the mating holder 5 contacts the closure 6, which is positioned on the container mouth 2.1.

Other embodiments of the filling-and-closing member 4 are possible. By way of example, in some embodiments, slide elements position the closures 6.

1-14. (canceled)

15. An apparatus for both filling and closing a container, said apparatus comprising a multi-purpose container-handler comprising a carrier for receiving and carrying said container, a handling station that extends along a vertical axis, and a filling-and-closing member arranged on said handling station, said filling-and-closing member being connected to a filling product supply and a closure supply and being configured to both fill and close said container at said handling station, wherein said filling-and-closing member comprises a filling valve and a mating holder, both of which are above said carrier, wherein said carrier and said mating holder are configured to carry out controlled vertical movement relative to one another to cause said carrier and said mating holder to transition between a starting position, a filling position and a closing position, and wherein either said carrier generates a controlled holding force directed vertically upward or said mating holder generates a controlled closing force directed vertically downward.

16. The apparatus of claim 15, wherein said carrier comprises a lift that moves a container vertically from a first plane to a second plane, wherein said first and second planes are selected from the group consisting of a supply plane, a filling plane, and a closing plane, wherein said filling plane is between said supply plane and said closing plane, and wherein said closing plane is higher than said supply plane.

17. The apparatus of claim 16, wherein said lift is pneumatically controlled.

18. The apparatus of claim 16, wherein said lift is mechanically controlled.

19. The apparatus of claim 16, wherein said lift is electrically controlled.

20. The apparatus of claim 16, further comprising a linear drive that drives said lift.

21. The apparatus of claim 15, wherein said mating holder is configured for movement along said vertical axis.

22. The apparatus of claim 15, wherein said filling-and-closing member comprises a chamber that receives said container's mouth and a closure located in contact at a contact surface of said mating holder.

23. The apparatus of claim 22, wherein said chamber comprises a process chamber.

24. The apparatus of claim 22, wherein said chamber comprises a pressure chamber.

25. The apparatus of claim 22, further comprising seals for sealing said chamber, wherein said seals move upward with a neck of said container as said container is being brought into a sealing position, thereby sealing said chamber and said container.

26. The apparatus of claim 25, wherein, as a result of controlled movement relative to each other, said carrier and said mating holder are further configured to adopt a sealing position, wherein, in said sealing position, said sealing location is established of said sealing elements with said container neck.

27. The apparatus of claim 15, wherein said filling-and-closing member further comprises a drawing-ring arrangement that comprises a drawing ring for causing plastic deformation of said closures and wherein said closures are crown corks.

28. The apparatus of claim 27, wherein said drawing ring of said drawing ring arrangement is configured for movement along said vertical axis.

29. The apparatus of claim 15, further comprising a carousel and a motor that rotates said carousel around a middle axis thereof, where said handling station is one of a plurality of handling stations, all of which are disposed on a circumference of said carousel, wherein said carousel comprises an upper part, a lower part, wherein said filling-and-closing member is mounted on said upper part, wherein said lower part comprises a carrier rim, and wherein said carrier is one of a plurality of carriers provided at said carrier rim.

30. The apparatus of claim 29, further comprising a height adjuster that is configured adjust a distance between said upper part and said lower part.

31. A method comprising filling and closing a container at a handling station of a multi-purpose container handler, said method comprising at said handling station, bringing said container into a filling position, filling said container, bringing said container into a closing position, and closing said container with a closure, wherein bringing said container into said filling position and into said closing position comprises causing controlled relative movement of a carrier and a mating holder provided in a filling-and-closing element of said handling station, said relative movement being along a vertical axis of said handling station, wherein bringing said container into said closing position comprises at least one of causing controlled exertion of a closing force by said mating holder and causing controlling exertion of a holding force by said carrier, and wherein said closing force is vertically downward and said holding force is vertically upward.

32. The method of claim 31, wherein causing controlled relative movement of said carrier comprises causing said carrier to lift said container from a supply plane into a filling plane above said supply plane and causing said carrier to lift said container from said filling plane to a closing plane that is higher than said filling plane.

33. The method of claim 31, wherein bringing said container into said closing position and bringing said container into said filling position comprise causing said mating holder to move in a controlled manner along a vertical axis of said handling station.
